(19) United States
(12) Patent Application Publication
(10) Pub. No.: US 2022/0174895 A1
(43) Pub. Date: Jun. 9, 2022

(54) REUSABLE AGRICULTURAL GROWTH MEDIUM CAPABLE OF CONTAINING GAS AND NUTRIENTS

(71) Applicant: W. L. Gore & Associates, Inc., Newark, DE (US)

(72) Inventors: Edward H. Cully, Newark, DE (US); Jeffrey B. Duncan, Flagstaff, AZ (US)

(21) Appl. No.: 17/598,964

(22) PCT Filed: Mar. 27, 2020
(86) PCT No.: PCT/US2020/025450

§ 371 Date: Sep. 28, 2021

Related U.S. Application Data
(60) Provisional application No. 62/825,249, filed on Mar. 28, 2019.

(51) Int. Cl. A01G 24/42; A01G 24/35

(52) U.S. Cl. CPC A01G 24/42; A01G 24/35

(57) ABSTRACT

Various disclosed examples relate to a growth medium including expanded polymer particulates, as well as a growth environment including the growth medium, a container housing a nutrient solution and a plant such that roots of the plant are received in the growth medium. Associated methods of preparing the growth medium are also contemplated, including sterilization of the growth medium and preparation of the growth medium with a growth promoting agent.

### CROSS-REFERENCE TO RELATED APPLICATION

This application is a national phase application of PCT Application No. PCT/US2020/025450, internationally filed on Mar. 27, 2020, which claims the benefit of Provisional Application No. 62/825,249, filed Mar. 28, 2019, which are incorporated herein by reference in their entireties for all purposes.

### FIELD

The present disclosure relates generally to an agricultural growth medium, and more specifically, to an expanded polymer agricultural growth medium that is reusable and also capable of containing gas and nutrients.

### BACKGROUND

Indoor agriculture has become more popular during recent years due to the amount of energy that can be saved, the efficiency with which water can be used, and the reduction of risks that usually come with traditional agriculture. With regard to saving energy, indoor agriculture uses grow lighting, including LEDs, such as canopy lights, to control the specific wavelength of light that the plantation receives. Plant growth results from the availability of nutrients, light, and carbon dioxide. Plants use chlorophyll and other pigments to absorb the energy of light and convert it into energy that the plants can use through a process called photosynthesis. For example, chlorophyll a, which is in all plants, absorbs most energy from wavelengths of violet-blue and orange-red light. Farmers can use the knowledge of the plants and their pigments to adjust which grow lights to use to save energy.

Specific kinds of indoor agriculture use water in a way unique from typical outdoor agriculture. For example, hydroponic agriculture uses no soil in growing plants, and includes all the nutrients and minerals that the plants need to grow in a water solvent to which the roots of the plants are exposed. Instead of soil, the plants are supported by an inert medium such as perlite or gravel. Also, the closed-loop irrigation system incorporated into some hydroponic operations saves over half of water usage and reduces the amount of fertilizers used, while preventing pollutants from entering the system, which can come from groundwater and soil.

Risk reduction is also a major factor that plays into the increase in popularity of indoor agriculture. For example, when plants are grown in a traditional outdoor agricultural method, there are greater risks of yield loss from pests, diseases, and inclement weather and other sources. Moreover, plants, which may yield edible vegetation and fruits, may be grown locally to reduce the distance from the food supply to the distributors, such restaurants, supermarkets, and local farmer's markets, thereby reducing shipping cost and helping to ensure freshness through local sourcing.

One of the goals in the indoor agriculture is to protect the plants from unwanted pathogens. This is especially true in fields of science such as agricultural biotechnology, where contamination of such pathogens causes errors in the results obtained from procedures that must be performed under a sterile environment. As such, hydroponic support medium is disclosed for plant growth in an indoor environment without using any soil, with water as well as the nutrient(s) necessary for the plant growth is provided in a nutrient solution. However, the support medium in these examples causes an increased pressure within the container that holds the support medium and the roots as the roots of the plant grows. This increased pressure can reduce relative room for air the container and may cause air within the container to be forced out or otherwise escape from the container. The effect of increased pressure is compounded by the nature of the rigid support medium, which is unable to hold much air. Generally, a lack of sufficient air in the container may suppress plant growth because plant roots utilize air for respiration. Furthermore, the support medium is susceptible to growth of algae and mold when water-logged, which is detrimental to the growth of the plant because such algae and mold starve the roots of much needed oxygen. Another problem faced by the support medium is that the roots grow very quickly to fill the medium and container, after which the roots are forced to grow out of the container and into the light, once again allowing for the algae to grow as well as other unwanted outcomes.

Furthermore, there is an increased demand for reusable growth medium that is considered a more environmentally friendly option for indoor agriculture. One challenge is finding a material that is chemically inert so that it can be effectively sterilized after each use. The process of sterilizing a growth medium can be important because, for example, as a plant grows, the plant's roots may enter and be received in the growth medium, possibly leaving plant pathogens inside the growth medium that may cause disease in the next plant that is to be grown in the medium. Therefore, the most reliable methods of sterilization are by using chemical agents, heat, or radiation. These methods, however, have their own setbacks.

With regard to chemical sterilization, hydrogen peroxide, alcohol, quaternary ammonium salts, and bleach are some of the popular options. Enzyme products can also be used to speed up the sterilization process in hydroponic medium. However, existing growth medium is often degradable so that using chemical agents repeatedly to sterilize the growth medium may cause the growth medium to be used a relatively small number of times before having to be thrown away. Heat sterilization is another option that has its own disadvantages. For example, if an oven is used to heat the growth medium, it can be difficult to know precisely how long the growth medium must be heated and at what temperature to ensure sterility. If heated too much, certain growth medium can cause unpleasant odors or fumes which may be harmful if inhaled. The same disadvantages exist for radiation sterilization. Typically, ultraviolet light irradiation is used for radiation-type of sterilization, but prolonged exposure to the radiation can cause damage in the growth medium and change the physical or chemical properties of the growth medium.

### SUMMARY

Disclosed herein are examples of growth medium configurations. According to one example, (“Example 1”), the growth medium includes expanded polymer particulates. The expanded polymer particulates carry one or more plant growth promoting agents and prevents spreading of microorganism on a surface and an inside thereof.

According to another example (“Example 2”) further to Example 1, the growth medium includes a hydrogel material associated with the expanded polymer particulates.

According to another example (“Example 3”) further to any of the preceding Examples, the one or more plant growth promoting agents includes a nutrient solution.

According to another example (“Example 4”) further to any of the preceding Examples, the one or more plant growth promoting agents includes gas maintained within the expanded polymer particulates.

According to another example (“Example 5”) further to Example 5, the gas comprises at least one of: air, oxygen, and nitrogen gas.

According to another example (“Example 6”) further to any of the preceding Examples, the expanded polymer particulates are inert and reusable.

According to another example (“Example 7”) further to any of the preceding Examples, the expanded polymer includes expanded polytetrafluoroethylene (ePTFE).

According to another example (“Example 8”) further to any of Examples 1-6, the expanded polymer includes expanded fluorinated ethylene propylene (eFEP).

According to another example (“Example 9”) further to any of Examples 1-6, the expanded polymer includes expanded polyethylene (ePE).

According to another example (“Example 10”) further to any of the preceding Examples, further including a plurality of layers of expanded polymer particulates. Each layer contains a set of expanded polymer particulates. Each set of expanded polymer particulates includes one or more plant growth promoting agents distinct from the one or more growth promoting agents of another one of the sets of expanded polymer particulates.

According to another example (“Example 11”), a growth environment includes the growth medium of any one of the preceding Examples received in a container housing a nutrient solution and a plant such that roots of the plant are received in the growth medium.

According to another example (“Example 12”), a method of preparing a growth medium includes: sterilizing expanded polymer particulates; filling the expanded polymer particulates with a first plant growth promoting agent; placing the expanded polymer particulates in a container; filling the container with a second plant growth promoting agent; and covering the container with a lid.

According to another example (“Example 13”) further to Example 12, the method further includes applying a layer of coating on the expanded polymer particulates.

According to another example (“Example 14”) further to Example 13, the coating is a hydrogel material.

According to another example (“Example 15”) further to any one of Examples 12-14, the first and second plant growth promoting agents are one or more of: a gas and a nutrient solution.

According to one example, (“Example 16”) further to Example 15, the gas comprises at least one of: air, oxygen, and nitrogen gas.

According to another example (“Example 17”) further to any one of Examples 12-16, the expanded polymer particulates are inert and reusable.

According to another example (“Example 18”) further to any one of Examples 12-17, the expanded polymer particulates comprise expanded polytetrafluoroethylene (ePTFE).

According to another example (“Example 19”) further to any of Examples 12-18, the expanded polymer particulates comprise expanded fluorinated ethylene propylene (eFEP).

According to another example (“Example 20”) further to any of Examples 12-19, the expanded polymer particulates comprise expanded polyethylene (ePE).

According to another example (“Example 21”) further to any of Examples 12-20, the method of preparing a growth medium further includes forming a plurality of layers of the expanded polymer particulates. Each layer contains a set of expanded polymer particulates. Each set of expanded polymer particulates includes one or more plant growth promoting agents distinct or different from the one or more growth promoting agents of another one of the sets of expanded polymer particulates.

According to another example (“Example 22”), a growth medium comprises expanded polymer particulates that have a porous microstructure. The expanded polymer particulates carry one or more plant growth promoting agents and are resistant to at least one of the attachment and the proliferation of microorganisms on an outer surface of the particulates. The expanded polymer particulates are also resistant to at least one of the attachment and the proliferation of microorganisms within the expanded polymer particulates.

According to another example (“Example 23”) further to Example 22, the growth medium further comprises a hydrogel material associated with the expanded polymer particulates.

According to another example (“Example 24”) further to Example 22 or 23, the one or more plant growth promoting agents includes a nutrient solution.

According to another example (“Example 25”) further to any one of Example 22 to 24, the one or more plant growth promoting agents comprises gas maintained within the expanded polymer particulates.

According to another example (“Example 26”) further to Example 25, the gas comprises at least one of air, oxygen, nitrogen gas, and combinations thereof.

According to another example (“Example 27”) further to any one of Example 22 to 26, the expanded polymer particulates are inert.

According to another example (“Example 28”) further to any one of Example 22 to 27, the expanded polymer particulates comprise expanded polytetrafluoroethylene (ePTFE).

According to another example (“Example 29”) further to any one of Example 22 to 28, the expanded polymer particulates comprise expanded fluorinated ethylene propylene (eFEP).

According to another example (“Example 30”) further to any one of Example 22 to 29, the expanded polymer particulates comprise expanded polyethylene (ePE).

According to another example (“Example 31”) further to any one of Example 22 to 30, each of the plurality of layers include a growth promoting agent that is different from a growth promoting agent of each other one of the plurality of layers.

According to another example (“Example 32”), a growth environment comprises a container, a nutrient solution in the container, the growth medium of any of Examples 22 to 31 received in the container, and a plant having roots received in the growth medium.

According to another example (“Example 33”), a method of preparing a growth environment comprises: sterilizing a growth medium including expanded polymer particulates, and treating the expanded polymer particulates with a first plant growth promoting agent.

According to another example (“Example 34”) further to Example 33, the method further includes placing the expanded polymer particulates in a container, and filling the container with a second plant growth promoting agent.

According to another example (“Example 35”) further to Example 33 or 34, the method further includes covering the container with a lid.

According to another example (“Example 36”) further to any of Examples 33 to 35, sterilizing the growth medium includes at least one of chemical, heat, and irradiation sterilization techniques.

According to another example (“Example 37”) further to any of Examples 33 to 36, the growth medium includes a hydrophilic treatment applied to the expanded polymer particulates.

According to another example (“Example 38”) further to Example 37, the hydrophilic treatment includes a hydrogel material applied to the expanded polymer particulates.

According to another example (“Example 39”) further to any of Examples 33 to 38, the first and second plant growth promoting agents are selected from a gas and a nutrient solution.

According to another example (“Example 40”) further to Example 33, the expanded polymer particulates comprise a porous microstructure. Also, treating the expanded polymer particulates with the first plant growth promoting agent includes causing the first plant growth promoting agent to be received within the porous microstructure of the expanded polymer particulates.

According to another example (“Example 41”) further to Example 40, the first plant growth promoting agent includes one or more of a nutrient solution and a gas maintained within the expanded polymer particulates, optionally at least one of air, oxygen, nitrogen gas, and combinations thereof.

According to another example (“Example 42”) further to any one of Example 33 to 41, the expanded polymer particulates are inert.

According to another example (“Example 43”) further to any one of Example 33 to 42, the expanded polymer particulates comprise expanded polytetrafluoroethylene (ePTFE).

According to another example (“Example 44”) further to any one of Example 33 to 43, the expanded polymer particulates comprise expanded fluorinated ethylene propylene (eFEP).

According to another example (“Example 45”) further to any one of Example 33 to 44, the expanded polymer particulates comprise expanded polyethylene (ePE).

According to another example (“Example 46”) further to any one of Example 33 to 45, the method of preparing a growth environment further includes forming a plurality of layers of the expanded polymer particulates. Each of the plurality of layers includes a growth promoting agent that is different from a growth promoting agent of each other one of the plurality of layers.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a schematic diagram of a soilless growth environment using a container, particulates, and nutrient solution in accordance with at least one embodiment;

FIG. 2 is a schematic diagram of a particulate as disclosed in FIG. 1 in accordance with at least one embodiment;

FIG. 3 is a schematic diagram of another soilless growth environment with layers of a particulate in accordance with at least one embodiment; and

FIG. 4 is a flow chart of a method of implementing the particulates to grow a plant in accordance with at least one embodiment.

FIG. 5 is a top view of the container shown in FIG. 1 in accordance with at least one embodiment.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error or minor adjustments made to optimize performance, for example. In the event it is determined that individuals having ordinary skill in the relevant arts would not readily ascertain values for such reasonably small differences, the terms “about” and “approximately” can be understood to mean plus or minus 10% of the stated value.

### DESCRIPTION OF VARIOUS EMBODIMENTS

Persons skilled in the art will readily appreciate that various aspects of the present disclosure can be realized by any number of methods and apparatus configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

FIG. 1 illustrates an example of a growth environment 100 for a photosynthetic organism such as a plant 102. The growth environment includes a container 104 which houses the plant 102 as it grows. The container houses a growth medium 105 including a nutrient solution 106 and particulates 108. As described below, in various examples the particulates 108 includes a polymer (e.g., fluoropolymer, polyethylene, or other) material. The top of the container 110 is generally covered with a lid 110 or is otherwise closed such that contents of the container 110 do not escape. FIG. 5 shows the top view of the container 110 shown in FIG. 1. The seal formed by the lid 110 does not need to be hermetic, and a portion of the plant 102 generally penetrates through the lid 110 to expose leaves of the plan 102 to light for performing photosynthesis. In FIG. 5, an opening 500 in the lid 110 is where the plant 102 penetrates the lid. Also, the lid 110 can help prevent particulates 108 from spilling from or otherwise inadvertently being removed from the container 104.

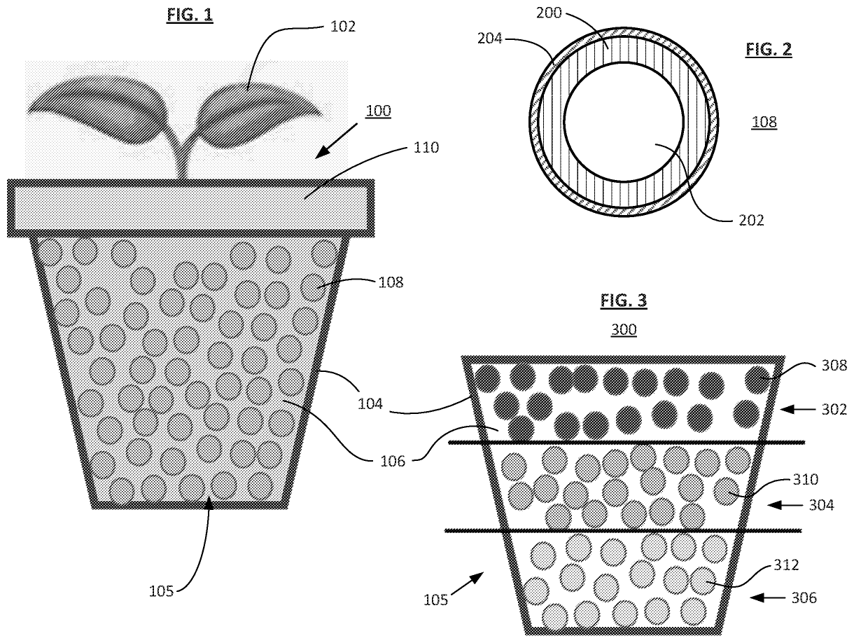

FIG. 2 illustrates an example of a structure of one of the particulates 108. The particulates 108 may have a plurality of layers, although fewer (i.e., a single layer) or more layers (i.e., greater than two layers) are used depending upon the desired implementation. In some embodiments, the particulates 108 includes a base, or base layer 200, which can be formed of a variety of materials, including an expanded fluoropolymer material such as expanded polytetrafluoroethylene (ePTFE), expanded fluorinated ethylene propylene (eFEP), combinations thereof, or other suitable polymeric materials such as expanded polyethylene (ePE). In some examples, the base layer 200 helps to define the overall structure (e.g., size and shape) of the expanded fluoropolymer particulates 108. The particulates 108 may include one or more additional layers, such as an inner layer 202 (or a plurality of inner layers) located on an interior side of the base layer 200. The inner layer 202 may be coupled directly to the base layer 200 (e.g., using adhesive and/or thermal bonding). The layer 202 may be configured as a carrier for solid(s), fluid(s), or gas(es) that promote plant 102 growth. The inner layer 202 is optionally formed of a fluoropolymer, such as an expanded fluoropolymer (e.g., ePTFE), configured to carry one or more growth promoting agents (e.g., internally within the structure of the inner layer 202, as a coating). Additionally, it should be noted that, although the present disclosure mentions each of the base layer 200, the inner layer 202 or any additional layer (e.g., an outer layer (not shown)) of the particulates 108 to have specific functions, the various functions of these layers as discussed herein are interchangeable and can be performed by any layer(s). For example, the inner layer 202 may define the structure of the particulates 108 and the base layer 200 may carry the material(s) essential for plant growth. In another example, all of the layers can perform the functions as specified, such that when the particulates 108 lacks one or more of the layers, the remaining layer(s) can substitute in performing these functions.

For example, in one embodiment, the inner layer 202 contains oxygen and allows oxygen to pass into the inner layer 202 (e.g., within a microstructure of the layer 202) that the root of the plant 102 can utilize as it grows. Specifically, when the plant grows, the roots of the plant will extend toward the particulates 108 in the solution 106. After the roots attach themselves to the particulates 108, the roots are able to withdraw the nutrients required for the plant 102. Oxygen is a vital element in the growth of a plant, as the lack of oxygen in a solution-only environment may cause the roots to “drown”. Therefore, in a typical hydroponic agriculture setting, the solution that the roots are immersed in needs to be infused with enough dissolved oxygen so that the plant can breathe in the solution. Providing oxygen in the inner layer 202 and/or the base layer 200, which may be similarly configured, can help achieve this purpose.

In another example, the inner layer 202 contains one or more mineral elements categorized as macronutrients and micronutrients. Macronutrients are what the plants utilize in large quantities to acquire what are often crucial cellular components, such as proteins and nucleic acids. Examples of macronutrient minerals include nitrogen, potassium, calcium, magnesium, phosphorus, and sulfur.

Macronutrients can be non-mineral as well, such as carbon, hydrogen, and oxygen. Micronutrients, on the other hand, are typically required only in relatively small amounts, often as cofactors for enzyme activity. Examples of micronutrient minerals include chlorine, iron, boron, manganese, zinc, copper, molybdenum, and nickel. Generally, plants need both macronutrients and micronutrients to grow and live, which thus may be considered “essential mineral elements”. There are also other mineral elements that promote plant growth but are not necessarily vital in completing the plant's life cycle. Such beneficial mineral elements include sodium, silicon, cobalt, and selenium. In various examples, these elements are included in addition to the essential mineral elements. Depending on plant growth needs, different combinations of the above minerals and gases may be included in the inner layer 202, or in any other layer as mentioned herein. Also, in some examples, the container 104 holds all the water, nutrient, and oxygen needed for the plant's entire desired cycle, so that there is no need to water the plant or to implement a hydroponic system. The desired cycle of the plant can vary based on what the plant is used for. For example, the desired cycle may be about 14 days of plant growth in agricultural biotechnology because that is the amount of time needed for the plant to develop virus-like particles (VLPs) which is a vital part of vaccinology. After the desired cycle, the plants can be taken out of their containers for further processing, and the particulates within the containers can then be sterilized and reused in a subsequent soilless growth environment. The method of placing everything needed for plant growth cycle (e.g., water, nutrient, and oxygen) within a container is commonly referred to as the “Kratky Method”. Using a medium within the container such as described herein may improve yield of this method.

As another additional or optional feature to those addressed above, in some embodiments, the content of the inner layer 202 can be adjusted to control the pH level within the growth environment 100. Plants grown in the growth environment 100 may have a different optimal pH level from those grown in other contexts, such as soil-grown plants. Therefore, in various contexts, it can be important to carefully consider pH levels, and maintain an appropriate pH level range in the growth environment 100. For example, the optimal pH range for many plants grown in a hydroponic environment is between 5.5 and 6.5, and some examples have a narrower range of between 5.8 and 6. If the pH level rises too high, and becomes too alkaline, plants are generally less efficient in absorbing the nutrients within the growth environment 100, causing the plant 102 to be malnourished even when there are enough nutrients in its surrounding. To maintain pH levels in a preferred range, an automated pH controller may be used to inject acid into the hydroponic system. As an additional or alternative mechanism, the particulates 108 may be configured to assist with pH control to reduce or even completely eliminate the need to use additional pH controllers. For example, the particulates 108 may include, and be configured to release pH adjusting content (e.g. an acidic substance) over time, or at a desired point in the growth cycle. For instance, the plant 102 may require a certain pH in the vegetative state yet require an alternate pH in the flowering or fruiting state.

The particulates 108 may also include an outer layer 204 located outwardly of the base layer 200 as the outermost layer. The outer layer 204 may be formed in a variety of manners, including extrusion, wrapping, coating, or other method. For example, the outer surface of the base layer 200 may be provided with a coating to serve as the outer layer 204. In one example, after the minerals and gases are injected into the inner layer 202, a coating of hydrogel is applied on the outer surface of the base layer 200, forming the outer layer 204. The outer layer 204 can help serve as a shield to help prevent contents of the inner layer 202 from prematurely escaping, or escaping at an undesirable rate, into the growth environment 100. For example, oxygen inside the particulates 108 may slowly escape into the solution 106, and because the lid 110 and the container 104 do not form a hermetic seal, the oxygen may escape from the opening on the lid 110 into the atmosphere outside the container 104. This scenario may be detrimental to plant growth because the roots of the plant 102 are not able to take advantage of the oxygen that otherwise escaped into the atmosphere. Other types of coating can be applied as well for similar or different purposes as desired. Further, multiple coatings can be applied as necessary to achieve a desired result (e.g., to control release of the contents of the particulates 108). As mentioned above, it should be noted that the content of any other layer(s), such as the base layer 200 and outer layer 204 as well as additional layers that can be implemented as needed, can be adjusted to control the pH level within the growth environment 100 and/or to prevent the contents of adjacent layer(s) from escaping. In some examples, each of the plurality of layers 200, 202, 204 includes a growth promoting agent that is different from a growth promoting agent of each other one of the plurality of layers

It should be noted that, although FIG. 2 illustrates the particulates 108 as round in nature, the particulates 108 can be of any appropriate size and shape and need not all share the same size and/or shape, which may in part be determined by the type and size of plant 102 that is to be grown in the medium. Suitable particulates 108 include, for example, those wherein each of the length, width and height of the particulates are less than about 20 mm, less than about 10 mm, less than about 7 mm, less than about 5 mm, or less than about 3 mm. In some examples, the particulates 108 may be in an elongated configuration such that the length is greater than the width and the height, in which case the length may be less than about 50 mm, less than about 40 mm, less than about 30 mm, less than about 20 mm, or less than about 10 mm. Moreover, the particulates 108 can include through-holes, perforations, macropores, micropores or other features to help allow plant roots to more easily access the nutrients within the particulates 108. Also, although FIG. 1 illustrates all particulates 108 to be of a similar size and shape, it should be noted that some of the particulates 108 can be larger or smaller than others and can also or alternatively vary in shape. In one embodiment, the particulates 108 can be dispersed throughout the container in a substantially equal concentration, while in other examples, there can be more particulates 108 concentrated near the top surface of the container 104 than on the bottom, or vice versa.

In some embodiments, the particulates 108 can be hydrophobic, hydrophilic, or both. Hydrophobic particulates may be particularly effective for storing nutrients, especially gases, on a time-delay basis. For example, because hydrophobic particulates do not dissolve well in a nutrient solution 106 which contains primarily water, the release of the gases can be delayed until the particulates 108 are physically punctured by the roots of the plant 102. As such, in one embodiment, one of the layers 200, 202, 204 can be hydrophobic while the other two layers are hydrophilic, or vice versa, so as to control the timing of when the stored nutrients are released. In some examples, an outer surface (for example, the outer layer 204 or an outer surface of the base layer 200) of the expanded polymer particulates 108 is resistant to at least one of the attachment and the proliferation of microorganisms. In some examples, the growth medium 105 may be resistant to at least one of the attachment and the proliferation of microorganisms within the expanded polymer particulates 108 (for example, within the inner layer 202).

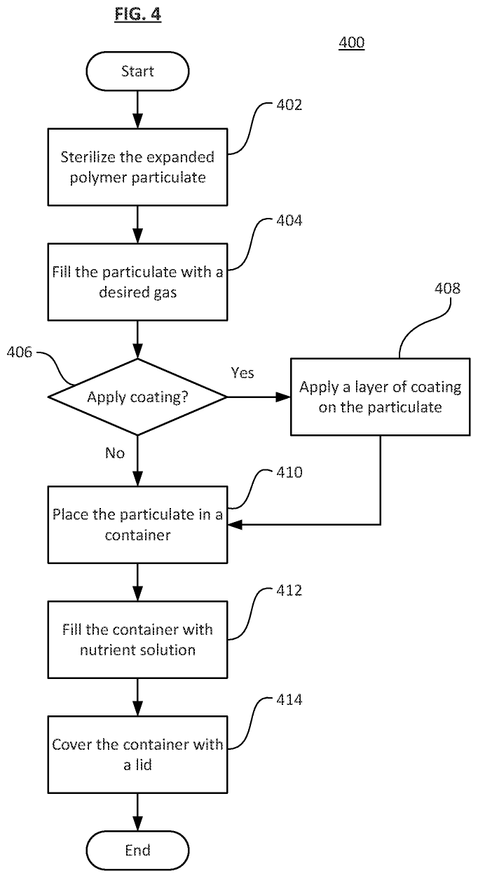

FIG. 3 illustrates an example of a layered growth environment 300 including a growth medium 105. In the growth environment 300, the growth medium 105 located within the container 106 is separated into three distinct layers that are formed, namely, a first layer 302, second layer 304, and third layer 306. Each layer includes a different set of particulates (e.g., having different configurations and/or contents). For example, each of the sets of particulates may have a different concentration of gas and is kept separate from the other sets of particulates. In the example of growth environment 300, the sets of particulates are separated into top, middle, and bottom layers, although they need not be separated horizontally, but may be formed as graduating sizes of rings, horizontal layers, or other configurations. Regardless, as shown in FIG. 3, the first layer 302 (top layer as shown) contains a first set of particulates 308, the second layer 304 (middle layer as shown) contains a second set of particulates 310, and the third layer 306 (bottom layer as shown) contains a third set of particulates 312. The liquid, solid, and/or gas contained inside the set of particulates of each layer accommodates for the different plant growth needs. For example, the first layer 302 may be positioned as the top layer and thus as the first set of particulates that the roots of a plant (not shown) would reach because the first layer would be closest to the surface, and as the roots grow, they extend deeper into the second layer 304 and ultimately into the third layer 306. The contents of each layer 302, 304, 306 may be designed to correlate with the plant's needs as it grows, such as by providing the right nutrients for vegetative growth in the first layer 302 such that the roots grow faster so more nutrient may be absorbed, and then providing alternative nutrients to promote foliage growth in the second layer 304 as well as flower and fruit production in the third layer 306.

For example, the first layer 302 may include a fertilizer that is richer in phosphorus and potassium than nitrogen, to increase the growth rate of the roots of the plant. In one example, the fertilizer may have a N-P-K ratio (i.e. the nitrogen-phosphorus-potassium ratio) of 3-20-20. Another example of the first layer 302 may include auxins which are plant hormones known to stimulate root growth (e.g. indole butyric acid and naphthylacetic acid). Furthermore, the second layer 304 and the third layer 306 may include more nitrogen to support the growth of foliage and/or fruits and flowers, as necessary. As illustrated, the particulate mixture inside the growth environment 300 may not be homogenous in properties, allowing for nutrients, oxygen, and/or other contents of the particulates to be arranged in a manner tailored for a particular plant and/or application.

One method of producing particulates suitable for use in growth environments, such as growth environments 100 or 300, is through material grinding to produce particulates of a desired fineness (or conversely, coarseness). In one example, expanded polyethylene (ePE), expanded polytetrafluoroethylene (ePTFE) and/or other materials can be used to form the particulates. Other suitable methods of producing the particulates may include chopping, cutting, molding, shredding, or other methodology.

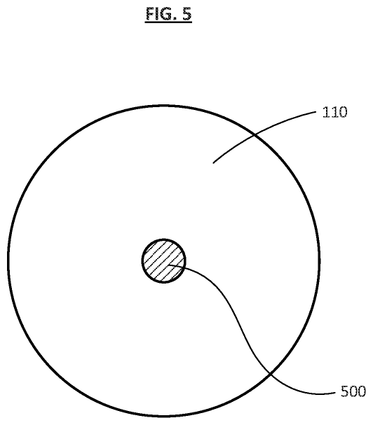

FIG. 4 depicts a flow chart of a method 400 of implementing a growth environment such as those described above. In a first step 402, the particulates 108 are sterilized. Then, the particulates 108 are filled with a plant growth promoting agent, which may be a desired gas for example, in step 404. In one embodiment, the desired gas can be oxygen or other gas(es) necessary for plant growth. In another example, a different nutrient, such as the aforesaid mineral macronutrient and micronutrient, can fill or partially fill the particulates 108 instead of, or in addition to. the desired gas. Next, in step 406, it is decided if a coating should be applied to the outer surface of the particulates 108. As described above, the coating can be a hydrogel such as potassium polyacrylate or sodium polyacrylate. If it is decided that the coating is necessary, in step 408, a layer of the coating is applied on the particulates 108. The coated particulates 108 are then placed in a container in step 410. Otherwise, if the coating is not necessary, the particulates 108 are placed in the container without a coating (step 408). Then, the container is filled with nutrient solution or a plant growth promoting agent in step 412. Finally, a lid is used to cover the container in step 414.

The foregoing description provides a variety of features and associated advantages for use with growth environments. In some embodiments, the particulates are compressible and/or conformable and allows plant roots to grow without undue stress or pressure applied to the roots and/or container. Using such particulates allows for less air to escape the container (e.g., in comparison to traditional soil environments). In another embodiment, the particulates are moldable to achieve a shape that is desired for the particulates' intended purpose(s).

In some embodiments, the particulates prevent adherence and spread of microorganism on a surface of the particulates as well as the insides thereof. For example, in certain growth environments, algae and fungi (including spores thereof) may be present. These microorganisms may be transported via airflow from outside the container and attach themselves to the inside or outside surface of the particulates. However, the material used in the particulates may be particularly resistant to the attachment and/or growth of such microorganisms. It has been surprisingly found that the use of ePTFE as a particulate material inhibits growth and proliferation of these microorganisms. For example, the hydrophobic properties of ePTFE may help prevent the microorganisms from adhering to the surfaces for extended periods. Thus, in various examples, the particulates are formed of a polymer, such as ePTFE, that is configured to inhibit microorganism growth. Furthermore, some particulates may take the form of ground ePTFE flakes, or another form that may be used to grow microorganisms in a liquid environment. For example, such particulates may be placed in a container with liquid seeded with one or more microorganism(s) (e.g. algae). The container may be exposed to a light source (e.g., placed under the sun) to encourage growth of the microorganism(s). The liquid may contain water, nutrients and/or other components necessary for growth of the microorganisms. It has been observed that algae may be grown under such conditions, where the algae grows in the liquid but not on the ePTFE flakes, which facilitates removal and harvesting of the algae.

In various embodiments, the particulates are inert and reusable. As previously discussed, protecting the plants from unwanted pathogens may be an important factor to place into consideration. In one example, the particulates are taken out of the container after a previous plant finishes growing in the growth medium made from the particulates, and then are sterilized via means such as chemical sterilization, heat sterilization, and/or sterilization via irradiation, among other methods. Once sterilization is completed, the particulates may be treated or reprocessed (also referred to herein as being “recharged”) to again contain the desired nutrients (also referred to herein as “rejuvenation”) and then placed into a container and again be used in growing a plant, which may be of a different type or species from the previous plant that was grown using the same particulates. In other words, by using an inert material such as ePTFE, pathogens may be easily eliminated without the particulates degrading during the sterilization process, and therefore the particulates are reusable for different plants. In some examples, the growth medium facilitates removal of plant roots (e.g., detached or disengaged) from the growth medium to facilitate cleaning and rejuvenation of the growth medium for the next cycle. The aforementioned sterilization and recharging processes may be further facilitated by the aforementioned ease of removal of the roots. Additionally, automation may be more easily introduced into the growing environment (e.g., automated harvesting systems). The aforementioned ease of removal, and the ability to sterilize/clean the growth medium, may help ensure consistent results through automation.

In another embodiment, the individual particulates can be configured with a desired shape, size and/or content, and the particulates forming a set of particulates can be varied to achieve differing shapes, sizes and/or content, and/or multiple sets of particulates (e.g., layers) can be varied in shape, size, and content. For example, the size of the particulates can be adjusted to account for very fine roots or larger roots, or other growing needs. In yet another embodiment, the particulates may be weighted to prevent the particulates, which may be filled with gas and/or have a low density, from floating to the top surface of the growth medium. One example of achieving weighted particulates includes attaching different antimicrobial polymers that are heavier than the polymers being used in the particulates (e.g., ePTFE), so that the weighted particulates can sink to the bottom layer of the container, as appropriate. In another embodiment, fine strands of material may be attached to the bottom of the container. The strands or ribbon-like particles may be processed in the same manner as above, and may tend to have buoyancy. Once the container is filled with water and nutrient solution, the aforementioned strands would tend to float upright. This embodiment may also serve the automation because the “growth medium” is integral with the container.

Another aspect is the reflective property of the particulates 108. For example, ePTFE is highly reflective, and depending on the process used to manufacture the ePTFE, the reflectance can reach upward of 90%, and in some cases above 95% or above 98% reflectance. Therefore, when ePTFE particulates or other reflective material is used, the particulates 108 prevent light from entering the root system of the plant, allowing the area inside the container 104 to remain substantially dark. This can be advantageous for the growth of certain types of plants (e.g., non-aquatic plants, which may grow better when the plant roots are not exposed to light).

In yet another embodiment, a “floating island” or “floating particulate mass” configuration is employed using the particulates as described herein. The floating island is formed by first preparing a plurality of layered particulates such that the inside of the particulates is filled with nutrient and other plant growth promoting agents as well as gas. Then, the particulates are joined together via various means such as netting, wrapping, bundling, gluing, and other methods of attaching separate particulates together. The conjoined particulates may form a “floating island” that can then be placed in an aquatic environment to allow for the particulates to remain floating for at least a predetermined period of time. In one example, this floating island configuration may be filled with seeds so as to allow the plants to grow within the island. In another example, this floating island configuration may also be used to clean polluted water in a large body of water such as a lake or reservoir by including certain types of bacteria within the particulates in a process called “bioencapsulation” so that the bacteria inside the particulates ingest the pollutants located in the water, such as hydrocarbons that are released into the water as a result of hydrofracking or an oil spill, thereby cleaning the lake or reservoir.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

1. A growth medium comprising expanded polymer particulate configured to carry one or more plant growth promoting agents and prevent spreading of microorganism on a surface and an inside thereof.

2. The growth medium of claim 1, further comprising a hydrogel material associated with the expanded polymer particulate.

3. The growth medium of claim 1, wherein the one or more plant growth promoting agents includes a nutrient solution.

4. The medium of claim 1, wherein the one or more plant growth promoting agents comprises gas maintained within the expanded polymer particulate.

5. The growth medium of claim 4, wherein the gas comprises at least one member selected from air, oxygen, nitrogen gas, and combinations thereof.

6. The growth medium of claim 1, wherein the expanded polymer particulate is inert and reusable.

7. The growth medium of claim 1, wherein the expanded polymer comprises expanded polytetrafluoroethylene (ePTFE).

8. The growth medium of claim 1, wherein the expanded polymer comprises expanded fluorinated ethylene propylene (eFEP).

9. The growth medium of claim 1, wherein the expanded polymer comprises expanded polyethylene (ePE).

10. The growth medium of claim 1, further comprising a plurality of layers of expanded polymer particulate, wherein each layer contains a set of expanded polymer particulates, and wherein each set of expanded polymer particulate includes one or more plant growth promoting agents distinct from the one or more growth promoting agents of each other sets of expanded polymer particulate.

11. A growth environment comprising the growth medium of claim 1 received in a container housing a nutrient solution and a plant such that roots of the plant are received in the growth medium.

12. A method of preparing a growth medium, comprising:
sterilizing expanded polymer particulate;
filling the expanded polymer particulate with a first plant growth promoting agent;
placing the expanded polymer particulate in a container;
filling the container with a second plant growth promoting agent; and
covering the container with a lid.

13. The method of claim 12, further comprising: applying a layer of coating on the expanded polymer particulate.

14. The method of claim 13, wherein the coating is a hydrogel material.

15. The method of claim 12, wherein the first and second plant growth promoting agents are selected from a gas and a nutrient solution.
